(19) United States
(12) Patent Application Publication
(10) Pub. No.: US 2014/0143372 A1
(43) Pub. Date: May 22, 2014

(54) SYSTEM AND METHOD OF CONSTRUCTING A MEMORY-BASED INTERCONNECT BETWEEN MULTIPLE PARTITIONS

(71) Applicant: Kyle Nahrgang, Malvern, PA (US)

(72) Inventor: Kyle Nahrgang, Malvern, PA (US)

(73) Assignee: Unisys Corporation, Blue Bell, PA (US)

(21) Appl. No.: 13/955,188

(22) Filed: Jul. 31, 2013

Related U.S. Application Data
(63) Continuation-in-part of application No. 13/731,217, filed on Dec. 31, 2012.
Application No. 13/731,217 is a continuation-in-part of application No. 13/681,644, filed on Nov. 20, 2012, now abandoned.

(51) Int. Cl. G06F 15/167

(52) U.S. Cl. CPC G06F 15/167
USPC 709/215

(57) ABSTRACT

The shared memory interconnect system provides an improved method for efficiently and dynamically sharing resources between two or more guest partitions. The system also provides a method to amend the parameters of the shared resources without resetting all guest partitions. In various embodiments, a XML file is used to dynamically define the parameters of shared resources. In one such embodiment using a XML or equivalent file, the interconnect system driver will establish a mailbox shared by each guest partition. The mailbox provides messaging queues and related structures between the guest partitions. In various embodiments, the interconnect system driver may use macros to locate each memory structure. The shared memory interconnect system allows a virtualization system to establish the parameters of shared resources during runtime.

### CROSS REFERENCE TO RELATED APPLICATIONS

The present application is a continuation-in-part and is related to and claims priority from application Ser. No. 13/731,217, filed Dec. 31, 2013 entitled “STEALTH APPLIANCE BETWEEN A STORAGE CONTROLLER AND A DISK ARRAY”; and the present application is a continuation-in-part and is related to and claims priority from application Ser. No. 13/681,644, filed Nov. 20, 2012, entitled “OPTIMIZED EXECUTION OF VIRTUALIZED SOFTWARE USING SECURELY PARTITIONED VIRTUALIZATION SYSTEM WITH DEDICATED RESOURCES”; the contents of both of which are incorporated herein by this reference and are not admitted to be prior art with respect to the present invention by the mention in this cross-reference section.

### TECHNICAL FIELD

The present application relates generally to utility resource meter reading and communications. In particular, the present application relates generally to systems and methods for providing optimized execution of virtualized software in a securely partitioned virtualization system having dedicated resources for each partition.

### BACKGROUND

Computer system virtualization allows multiple operating systems and processes to share the hardware resources of a host computer. Ideally, the system virtualization provides resource isolation so that each operating system does not realize that it is sharing resources with another operating system and does not adversely affect the execution of the other operating system. Such system virtualization enables applications including server consolidation, co-located hosting facilities, distributed web services, applications mobility, secure computing platforms, and other applications that provide for efficient use of underlying hardware resources.

Virtual machine monitors (VMMs) have been used since the early 1970s to provide a software application that virtualizes the underlying hardware so that applications running on the VMMs are exposed to the same hardware functionality provided by the underlying machine without actually “touching” the underling hardware. As IA-32, or x86, architectures became more prevalent, it became desirable to develop VMMs that would operate on such platforms. Unfortunately, the IA-32 architecture was not designed for full virtualization as certain supervisor instructions had to be handled by the VMM for correct virtualization, but could not be handled appropriately because use of these supervisor instructions could not be handled using existing interrupt handling techniques.

Existing virtualization systems, such as those provided by VMWare and Microsoft, have developed relatively sophisticated virtualization systems that address these problems with IA-32 architecture by dynamically rewriting portions of the hosted machine's code to insert traps wherever VMM intervention might be required and to use binary translation to resolve the interrupts. This translation is applied to the entire guest operating system kernel since all non-trapping privileged instructions have to be caught and resolved. Furthermore, VMWare and Microsoft solutions generally are architected as a monolithic virtualization software system that hosts each virtualized system.

The complete virtualization approach taken by VMWare and Microsoft has significant processing costs and drawbacks based on assumptions made by those systems. For example, in such systems, it is generally assumed that each processing unit of native hardware can host many different virtual systems, thereby allowing disassociation of processing units and virtual processing units exposed to non-native software hosted by the virtualization system. If two or more virtualization systems are assigned to the same processing unit, these systems will essentially operate in a time-sharing arrangement, with the virtualization software detecting and managing context switching between those virtual systems.

Although this time-sharing arrangement of virtualized systems on a single processing unit takes advantage of otherwise idle cycles of the processing unit, it is not without side effects that present serious drawbacks. For example, in modern microprocessors, software can dynamically adjust performance and power consumption by writing a setting to one or more power registers in the microprocessor. If such registers are exposed to virtualized software through a virtualization system, those virtualized software systems might alter performance in a way that is directly adverse to virtualized software systems maintained by a different virtualization system, such as by setting a lower performance level than is available when an co-executing virtualized system is running a computing-intensive operation that would execute most efficiently if performance of the processing unit is maximized.

Because typical virtualization systems are designed to support sharing of a processing unit by different virtualized systems, they require saving and restoration of the system state of each virtualized system during a context switch between such systems. This includes, among other features, copying contents of registers into register “books” in memory. This can include, for example, all of the floating point registers, as well as the general purpose registers, power registers, debug registers, and performance counter registers that might be used by each virtualized system, and which might also be used by a different virtualized system executing on the same processing unit. For that reason, each virtualized system that is not the currently-active system executing on the processing unit requires this set of books to be stored for that system.

This storage of resource state for each virtualized system executing on a processing unit involves use of memory resources that can be substantial, due to the use of possibly hundreds of registers, the contents of which require storage. It also provides a substantial performance degradation effect, since each time a context switch occurs (either due to switching among virtualized systems or due to handling of interrupts by the virtualization software) the books must be copied and/or updated.

Further drawbacks exist in current virtualization software as well. For example, if one virtualized system requires many disk operations, that virtualized system will typically generate many disk interrupts, thereby either delaying execution of other virtualized systems or causing many context switches as data is retrieved from disk (and attendant requirements of register books storage and performance degradation). Additionally, because many existing virtualization systems are constructed as a monolithic software system, and because those systems generally are required to be executing in a high-priority execution mode, those virtualization systems are generally incapable of recovery from a critical (uncorrectable) error in execution of the virtualization software itself. This is because those virtualization systems either execute or fail as a whole, or because they execute on common hardware (e.g., common processors time-shared by various components of the virtualization system).

Typical virtualization systems use at least one partition to divide and share memory resources. Each partitioned block of memory may support a guest software system. In order to allow one partitioned guest system to communicate with another partitioned guest system, virtualization systems have used a piece of shared memory common to the two or more partitioned blocks of memory. This shared memory may be known as a mailbox, which supports messaging queues and related structures. Traditionally, the parameters for the mailbox (e.g., signal queue size, etc.) are established by drivers during boot up. Thus, the parameters of the mailbox are static after initial setup. Therefore, it is desirable to provide a system that can dynamically and safely define the mailbox parameters during runtime.

For these and other reasons, improvements are desirable.

### SUMMARY

In accordance with at least one exemplary embodiment, the above and other issues are addressed by a method disclosing the steps of reading at least one mailbox parameter in a parameter file, initializing a shared mailbox memory space in a first guest partition, the shared mailbox memory space accessible by a second guest partition different from the first guest partition, wherein the shared mailbox memory space is configured based, at least in part, on the at least one mailbox parameter, and notifying the second guest partition after the shared mailbox memory space is initialized.

In accordance with at least one exemplary embodiment, the above and other issues are addressed by a computer program product disclosing a non-transitory computer readable medium further comprising code to read at least one mailbox parameter in a parameter file, code to initialize a shared mailbox memory space in a first guest partition, the shared mailbox memory space accessible by a second guest partition different from the first guest partition, wherein the shared mailbox memory space is configured based, at least in part, on the at least one mailbox parameter; and code to notify the second guest partition after the shared mailbox memory space is initialized.

In accordance with at least one exemplary embodiment, the above and other issues are addressed by a computing system for executing non-native software having a plurality of processing units, each processing unit configured to execute native instructions on separate guest partitions, each guest partition sharing a shared mailbox memory space with another guest partition, the computing system comprising at least one processor coupled to a memory, in which the at least one processor is configured to read at least one mailbox parameter in a parameter file; and initialize a shared mailbox memory space in a first guest partition, the shared mailbox memory space accessible by a second guest partition different from the first guest partition, wherein the shared mailbox memory space is configured based, at least in part, on the at least one mailbox parameter; and notify the second guest partition after the shared mailbox memory space is initialized.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures.

It is to be expressly understood, however, that each of the figures is provided for the purpose of illustration and description only and is not intended as a definition of the limits of the present disclosure.

### BRIEF DESCRIPTION OF THE DRAWINGS

FIG. 1 illustrates system infrastructure partitions in an exemplary embodiment of a host system partitioned using the para-virtualization system of the present disclosure;

FIG. 2 illustrates the partitioned host of FIG. 1 and the associated partition monitors of each partition;

FIG. 3 illustrates memory mapped communication channels amongst various partitions of the para-virtualization system of FIG. 1:

FIG. 4 illustrates an example correspondence between partitions and hardware in an example embodiment of the present disclosure;

FIG. 5 illustrates a flowchart of methods and systems for reducing overhead during a context switch, according to a possible embodiment of the present disclosure; and

FIG. 6 illustrates a flowchart of methods and systems for recovering from an uncorrectable error in any of the partitions used in a para-virtualization system of the present disclosure;

FIG. 7 illustrates an example of at least two guest operating systems sharing a shared mailbox memory space on the same physical platform, according to a possible embodiment of the present disclosure;

FIG. 8 illustrates an example of at least two port spaces, each possessing at least a port header and a signal queue space, according to a possible embodiment of the present disclosure;

FIG. 9 illustrates a flowchart of methods and systems for sharing a mailbox memory space, according to a possible embodiment of the present disclosure; and

FIG. 10 illustrates an example of allocated block sharing within a signal queue space, according to a possible embodiment of the present disclosure.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to methods and systems for providing a securely partitioned virtualization system having dedicated physical resources for each partition. In some examples a virtualization system has separate portions, referred to herein as monitors, used to manage access to various physical resources on which virtualized software is run. In some such examples, a correspondence between the physical resources available and the resources exposed to the virtualized software allows for control of particular features, such as recovery from errors, as well as minimization of overhead by minimizing the set of resources required to be tracked in memory when control of particular physical (native) resources “change hands” between virtualized software.

Those skilled in the art will appreciate that the virtualization design of the invention minimizes the impact of hardware or software failure anywhere in the system while also allowing for improved performance by permitting the hardware to be “touched” in certain circumstances, in particular, by recognizing a correspondence between hardware and virtualized resources. These and other performance aspects of the system of the invention will be appreciated by those skilled in the art from the following detailed description of the invention.

In the context of the present disclosure, virtualization software generally corresponds to software that executes natively on a computing system, through which non-native software can be executed by hosting that software with the virtualization software exposing those native resources in a way that is recognizable to the non-native software. By way of reference, non-native software, otherwise referred to herein as “virtualized software” or a “virtualized system”, refers to software not natively executable on a particular hardware system, for example due to it being written for execution by a different type of microprocessor configured to execute a different native instruction set. In some of the examples discussed herein, the native software set can be the x86-32, x86-64, or IA64 instruction set from Intel Corporation of Sunnyvale, Calif., while the non-native or virtualized system might be compiled for execution on an OS2200 system from Unisys Corporation of Blue Bell, Pa. However, it is understood that the principles of the present disclosure are not thereby limited.

In general, and as further discussed below, the present disclosure provides virtualization infrastructure that allows multiple guest partitions to run within a corresponding set of host hardware partitions. By judicious use of correspondence between hardware and software resources, it is recognized that the present disclosure allows for improved performance and reliability by dedicating hardware resources to that particular partition. When a partition requires service (e.g., in the event of an interrupt or other issues which indicate a requirement of service by virtualization software), overhead during context switching is largely avoided, since resources are not used by multiple partitions. When the partition fails, those resources associated with a partition may identify the system state of the partition to allow for recovery. Furthermore, due to a distributed architecture of the virtualization software as described herein, continuous operation of virtualized software can be accomplished.

I. Para-Virtualization System Architecture

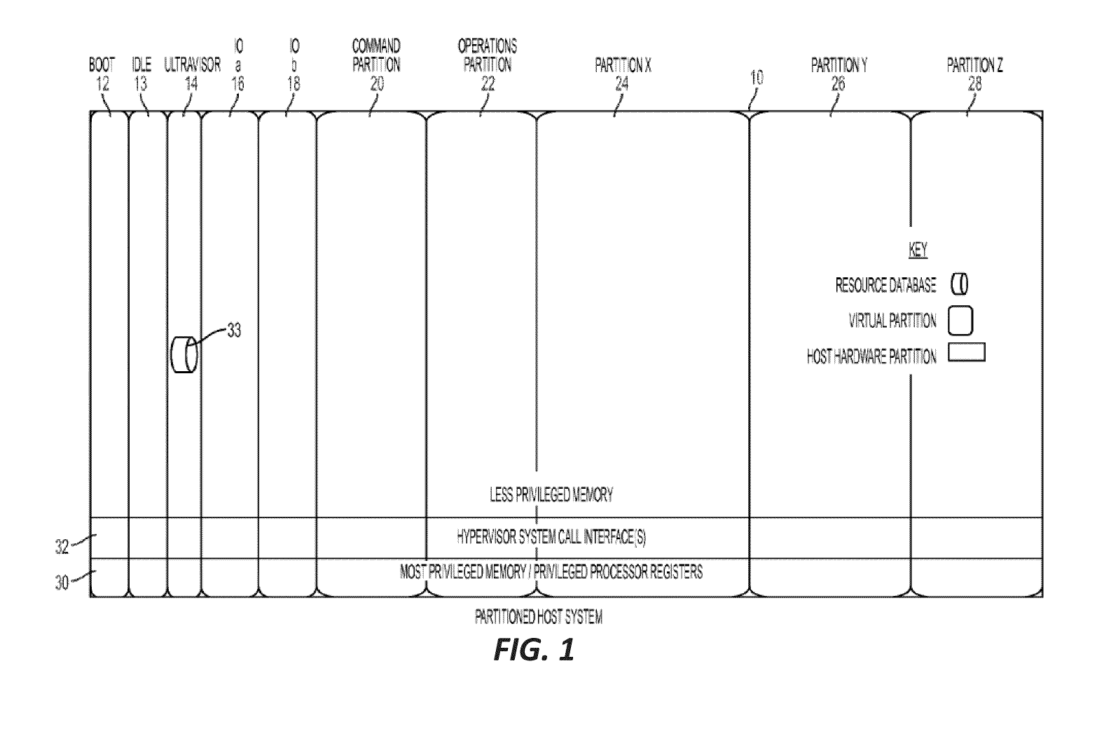

Referring to FIG. 1, an example arrangement of a para-virtualization system is shown that can be used to accomplish the features mentioned above. In some embodiments, the architecture discussed herein uses the principle of least privilege to run code at the lowest practical privilege. To do this, special infrastructure partitions run resource management and physical I/O device drivers. FIG. 1 illustrates system infrastructure partitions on the left and user guest partitions on the right. Host hardware resource management runs as an ultravisor application in a special ultravisor partition. This ultravisor application implements a server for a command channel to accept transactional requests for assignment of resources to partitions. The ultravisor application maintains the master in-memory database of the hardware resource allocations. The ultravisor application also provides a read only view of individual partitions to the associated partition monitors.

In FIG. 1, partitioned host (hardware) system (or node) 10 has lesser privileged memory that is divided into distinct partitions including special infrastructure partitions such as boot partition 12, idle partition 13, ultravisor partition 14, first and second I/O partitions 16 and 18, command partition 20, and operations partition 22, as well as virtual guest partitions 24, 26, and 28. As illustrated, the partitions 12-28 do not directly access the underlying privileged memory and processor registers 30 but instead accesses the privileged memory and processor registers 30 via a hypervisor system call interface 32 that provides context switches amongst the partitions 12-28 in a conventional fashion. Unlike conventional VMMs and hypervisors, however, the resource management functions of the partitioned host system 10 of FIG. 1 are implemented in the special infrastructure partitions 12-22. Furthermore, rather than requiring re-write of portions of the guest operating system, drivers can be provided in the guest operating system environments that can execute system calls. As explained in further detail in U.S. Pat. No. 7,984,104, assigned to Unisys Corporation of Blue Bell, Pa., these special infrastructure partitions 12-22 control resource management and physical I/O device drivers that are, in turn, used by operating systems operating as guests in the guest partitions 24-28. Of course, many other guest partitions may be implemented in a particular partitioned host system 10 in accordance with the techniques of the present disclosure.

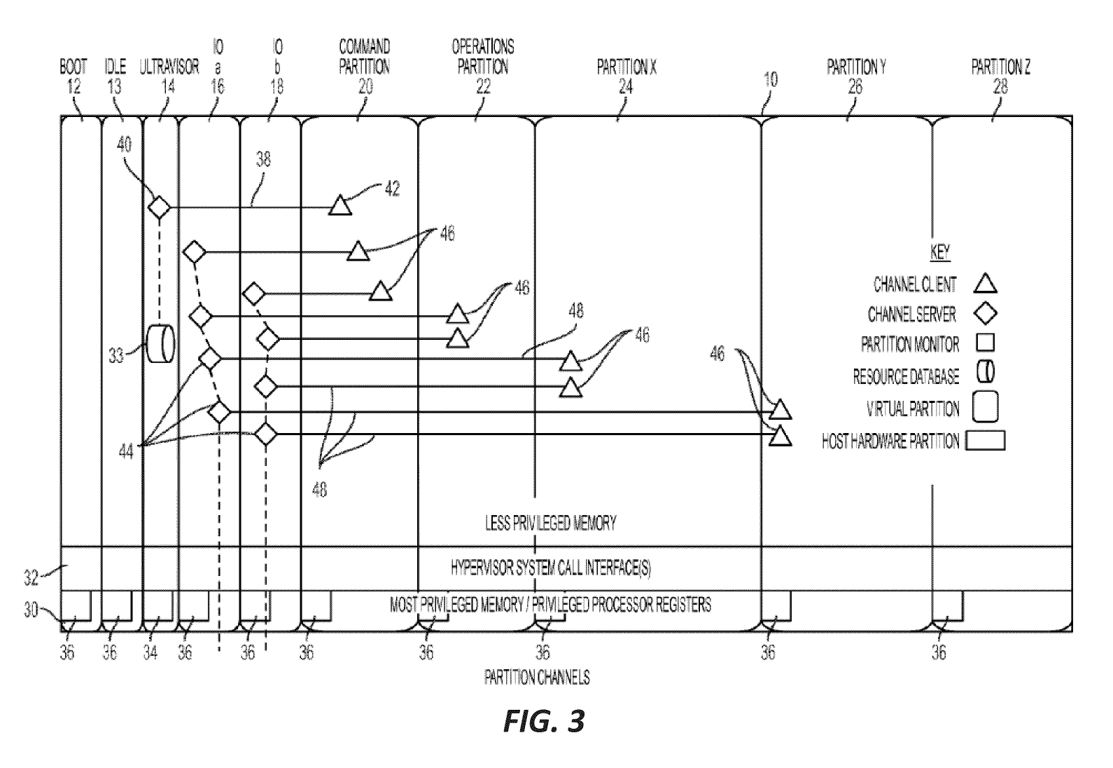

A boot partition 12 contains the host boot firmware and functions to initially load the ultravisor, I/O and command partitions (elements 14-20). Once launched, the resource management “ultravisor” partition 14 includes minimal firmware that tracks resource usage using a tracking application referred to herein as an ultravisor or resource management application. Host resource management decisions are performed in command partition 20 and distributed decisions amongst partitions in one or more host partitioned systems 10 are managed by operations partition 22. I/O to disk drives and the like is controlled by one or both of I/O partitions 16 and 18 so as to provide both failover and load balancing capabilities. Operating systems in the guest partitions 24, 26, and 28 communicate with the I/O partitions 16 and 18 via memory channels (FIG. 3) established by the ultravisor partition 14. The partitions communicate only via the memory channels. Hardware I/O resources are allocated only to the I/O partitions 16, 18. In the configuration of FIG. 1, the hypervisor system call interface 32 is essentially reduced to a context switching and containment element (monitor) for the respective partitions.

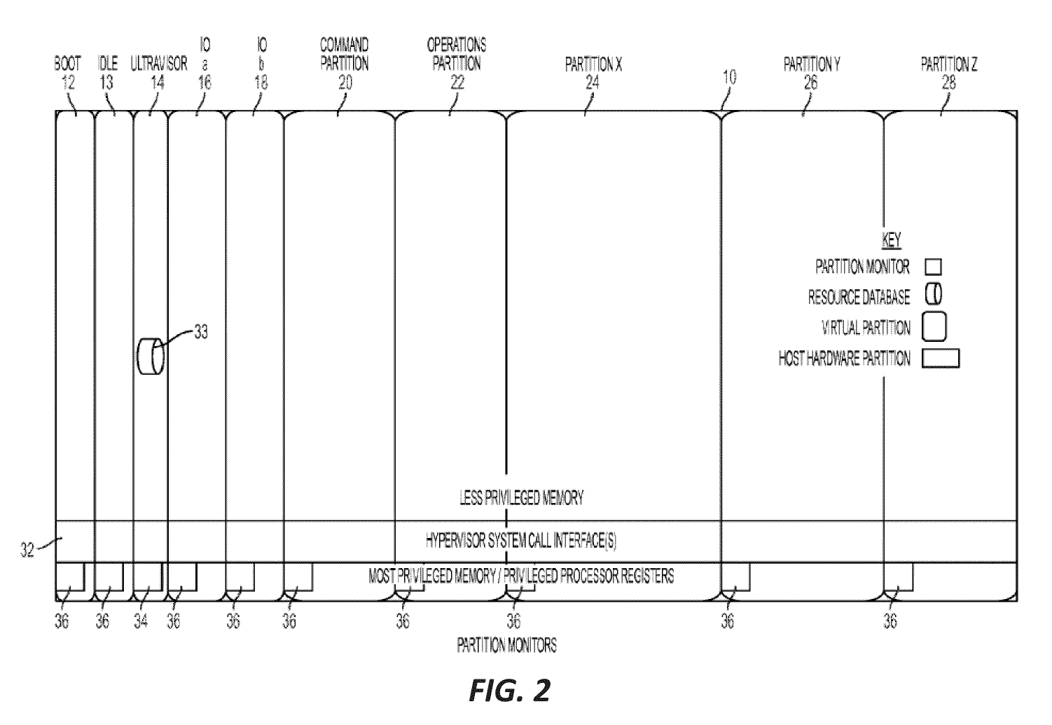

The resource manager application of the ultravisor partition 14, shown as application 40 in FIG. 3, manages a resource database 33 that keeps track of assignment of resources to partitions and further serves a command channel 38 to accept transactional requests for assignment of the resources to respective partitions. As illustrated in FIG. 2, ultravisor partition 14 also includes a partition (lead) monitor 34 that is similar to a virtual machine monitor (VMM) except that it provides individual read-only views of the resource database in the ultravisor partition 14 to associated partition monitors 36 of each partition. Thus, unlike conventional VMMs, each partition has its own monitor instance 36 such that failure of the monitor 36 does not bring down the entire host partitioned system 10. As will be explained below, the guest operating systems in the respective partitions 24, 26, 28 (referred to herein as “guest partitions”) are modified to access the associated partition monitors 36 that implement together with hypervisor system call interface 32 a communications mechanism through which the ultravisor, I/O, and any other special infrastructure partitions 14-22 may initiate communications with each other and with the respective guest partitions. However, to implement this functionality, those skilled in the art will appreciate that the guest operating systems in the guest partitions 24, 26, 28 must be modified so that the guest operating systems do not attempt to use the “broken” instructions in the x86 system that complete virtualization systems must resolve by inserting traps. Basically, the approximately 17 “sensitive” IA32 instructions (those which are not privileged but which yield information about the privilege level or other information about actual hardware usage that differs from that expected by a guest OS) are defined as “undefined” and any attempt to run an unaware OS at other than ring zero will likely cause it to fail but will not jeopardize other partitions. Such “para-virtualization” requires modification of a relatively few lines of operating system code while significantly increasing system security by removing many opportunities for hacking into the kernel via the “broken” (“sensitive”) instructions. Those skilled in the art will appreciate that the partition monitors 36 could instead implement a “scan and fix” operation whereby runtime intervention is used to provide an emulated value rather than the actual value by locating the sensitive instructions and inserting the appropriate interventions.

The partition monitors 36 in each partition constrain the guest OS and its applications to the assigned resources. Each monitor 36 implements a system call interface 32 that is used by the guest OS of its partition to request usage of allocated resources. The system call interface 32 includes protection exceptions that occur when the guest OS attempts to use privileged processor op-codes. Different partitions can use different monitors 36. This allows support of multiple system call interfaces 32 and for these standards to evolve over time. It also allows independent upgrade of monitor components in different partitions.

The monitor 36 is preferably aware of processor capabilities so that it may be optimized to utilize any available processor virtualization support. With appropriate monitor 36 and processor support, a guest OS in a guest partition (e.g., 24-28) need not be aware of the ultravisor system of the invention and need not make any explicit ‘system’ calls to the monitor 36. In this case, processor virtualization interrupts provide the necessary and sufficient system call interface 32. However, to optimize performance, explicit calls from a guest OS to a monitor system call interface 32 are still desirable.

The monitor 36 also maintains a map of resources allocated to the partition it monitors and ensures that the guest OS (and applications) in its partition use only the allocated hardware resources. The monitor 36 can do this since it is the first code running in the partition at the processor's most privileged level. The monitor 36 boots the partition firmware at a decreased privilege. The firmware subsequently boots the OS and applications. Normal processor protection mechanisms prevent the firmware, OS, and applications from ever obtaining the processor's most privileged protection level.

Unlike a conventional VMM, a monitor 36 has no I/O interfaces. All I/O is performed by I/O hardware mapped to I/O partitions 16, 18 that use memory channels to communicate with their client partitions. The primary responsibility of a monitor 36 is instead to protect processor provided resources (e.g., processor privileged functions and memory management units). The monitor 36 also protects access to I/O hardware primarily through protection of memory mapped I/O. The monitor 36 further provides channel endpoint capabilities which are the basis for I/O capabilities between guest partitions.

The monitor 34 for the ultravisor partition 14 is a ‘lead’ monitor with two special roles. It creates and destroys monitor instances 36, and also provides services to the created monitors 36 to aid processor context switches. During a processor context switch, monitors 34, 36 save the guest partition state in the virtual processor structure, save the privileged state in virtual processor structure (e.g. IDTR, GDTR, LDTR, CR3) and then invoke the ultravisor monitor switch service. This service loads the privileged state of the target partition monitor (e.g. IDTR, GDTR, LDTR, CR3) and switches to the target partition monitor which then restores the remainder of the guest partition state.

The most privileged processor level (i.e. x86 ring 0) is retained by having the monitor instance 34, 36 running below the system call interface 32. This is most effective if the processor implements at least three distinct protection levels: e.g., x86 ring 1, 2, and 3 available to the guest OS and applications. The ultravisor partition 14 connects to the monitors 34, 36 at the base (most privileged level) of each partition. The monitor 34 grants itself read only access to the partition descriptor in the ultravisor partition 14, and the ultravisor partition 14 has read only access to one page of monitor state stored in the resource database 33.

Those skilled in the art will appreciate that the monitors 34, 36 of the invention are similar to a classic VMM in that they constrain the partition to its assigned resources, interrupt handlers provide protection exceptions that emulate privileged behaviors as necessary, and system call interfaces are implemented for “aware” contained system code. However, as explained in further detail below, the monitors 34, 36 of the invention are unlike a classic VMM in that the master resource database 33 is contained in a virtual (ultravisor) partition for recoverability, the resource database 33 implements a simple transaction mechanism, and the virtualized system is constructed from a collection of cooperating monitors 34, 36 whereby a failure in one monitor 34, 36 need not doom all partitions (only containment failure that leaks out does). As such, as discussed below, failure of a single physical processing unit need not doom all partitions of a system, since partitions are affiliated with different processing units.

The monitors 34, 36 of the invention are also different from classic VMMs in that each partition is contained by its assigned monitor, partitions with simpler containment requirements can use simpler and thus more reliable (and higher security) monitor implementations, and the monitor implementations for different partitions may, but need not be, shared. Also, unlike conventional VMMs, a lead monitor 34 provides access by other monitors 36 to the ultravisor partition resource database 33.

Partitions in the ultravisor environment include the available resources organized by host node 10. A partition is a software construct (that may be partially hardware assisted) that allows a hardware system platform (or hardware partition) to be ‘partitioned’ into independent operating environments. The degree of hardware assist is platform dependent but by definition is less than 100% (since by definition a 100% hardware assist provides hardware partitions). The hardware assist may be provided by the processor or other platform hardware features. From the perspective of the ultravisor partition 14, a hardware partition is generally indistinguishable from a commodity hardware platform without partitioning hardware.

Unused physical processors are assigned to a special ‘Idle’ partition 13. The idle partition 13 is the simplest partition that is assigned processor resources. It contains a virtual processor for each available physical processor, and each virtual processor executes an idle loop that contains appropriate processor instructions to minimize processor power usage. The idle virtual processors may cede time at the next ultravisor time quantum interrupt, and the monitor 36 of the idle partition 13 may switch processor context to a virtual processor in a different partition. During host bootstrap, the boot processor of the boot partition 12 boots all of the other processors into the idle partition 13.

In some embodiments, multiple ultravisor partitions 14 are also possible for large host partitions to avoid a single point of failure. Each would be responsible for resources of the appropriate portion of the host system 10. Resource service allocations would be partitioned in each portion of the host system 10. This allows clusters to run within a host system 10 (one cluster node in each zone) and still survive failure of an ultravisor partition 14.

As illustrated in FIGS. 1-3, each page of memory in an ultravisor enabled host system 10 is owned by one of its partitions. Additionally, each hardware I/O device is mapped to one of the designated I/O partitions 16, 18. These I/O partitions 16, 18 (typically two for redundancy) run special software that allows the I/O partitions 16, 18 to run the I/O channel server applications for sharing the I/O hardware. Alternatively, for I/O partitions executing using a processor implementing Intel's VT-d technology, devices can be assigned directly to non-I/O partitions. Irrespective of the manner of association, such channel server applications include Virtual Ethernet switch (provides channel server endpoints for network channels) and virtual storage switch (provides channel server endpoints for storage channels). Unused memory and I/O resources are owned by a special ‘Available’ pseudo partition (not shown in figures). One such “Available” pseudo partition per node of host system 10 owns all resources available for allocation.

Referring to FIG. 3, virtual channels are the mechanism partitions use in accordance with the invention to connect to zones and to provide fast, safe, recoverable communications amongst the partitions. For example, virtual channels provide a mechanism for general I/O and special purpose client/server data communication between guest partitions 24, 26, 28 and the I/O partitions 16, 18 in the same host. Each virtual channel provides a command and I/O queue (e.g., a page of shared memory) between two partitions. The memory for a channel is allocated and ‘owned’ by the guest partition 24, 26, 28. The ultravisor partition 14 maps the channel portion of client memory into the virtual memory space of the attached server partition. The ultravisor application tracks channels with active servers to protect memory during teardown of the owner guest partition until after the server partition is disconnected from each channel. Virtual channels can be used for command, control, and boot mechanisms as well as for traditional network and storage I/O.

As shown in FIG. 3, the ultravisor partition 14 has a channel server 40 that communicates with a channel client 42 of the command partition 20 to create the command channel 38. The I/O partitions 16, 18 also include channel servers 44 for each of the virtual devices accessible by channel clients 46. Within each guest virtual partition 24, 26, 28, a channel bus driver enumerates the virtual devices, where each virtual device is a client of a virtual channel. The dotted lines in I/Oa partition 16 represent the interconnects of memory channels from the command partition 20 and operations partitions 22 to the virtual Ethernet switch in the I/Oa partition 16 that may also provide a physical connection to the appropriate network zone. The dotted lines in I/Ob partition 18 represent the interconnections to a virtual storage switch.

Redundant connections to the virtual Ethernet switch and virtual storage switches are not shown in FIG. 3. A dotted line in the ultravisor partition 14 from the command channel server 40 to the transactional resource database 33 shows the command channel connection to the transactional resource database 33.

A firmware channel bus (not shown) enumerates virtual boot devices. A separate bus driver tailored to the operating system enumerates these boot devices as well as runtime only devices. Except for I/O virtual partitions 16, 18, no PCI bus is present in the virtual partitions. This reduces complexity and increases the reliability of all other virtual partitions.

Virtual device drivers manage each virtual device. Virtual firmware implementations are provided for the boot devices, and operating system drivers are provided for runtime devices. Virtual device drivers may also be used to access shared memory devices and creating a shared memory interconnect between two or more guest partitions. The device drivers convert device requests into channel commands appropriate for the virtual device type.

In the case of a multi-processor host 10, all memory channels 48 are served by other virtual partitions. This helps to minimize the size and complexity of the hypervisor system call interface 32. For example, a context switch is not required between the channel client 46 and the channel server 44 of I/O partition 16 since the virtual partition serving the channels is typically active on a dedicated physical processor.

Additional details regarding possible implementations of an ultravisor arrangement is discussed in U.S. Pat. No. 7,984,104, assigned to Unisys Corporation of Blue Bell, Pa., the disclosure of which is hereby incorporated by reference in its entirety.

According to a further embodiment, a memory-based interconnect between multiple partitions may provide access to shared memory between two or more guest partitions. A mailbox, shared by the two or more guest partitions, is created to store messaging queues and/or other related structures. Unlike traditional mailbox structures which are statically defined and must be recompiled to change layout or size, the disclosed mailbox is dynamic. The mailbox may be dynamically configured according to a parameter file read at or before the time of initialization of the shared memory. In one embodiment, this is achieved by defining the quantity of each support structure(s), along with other parameters, within a structural file, such as an extensible markup language (XML) file that the hypervisor system call interface accesses during boot. The shared memory driver code uses the information within the parameters to establish the mailbox, such as by using macros to find the location of each structure. This process may be executed during runtime if the device is reset to ensure the device is not in use.

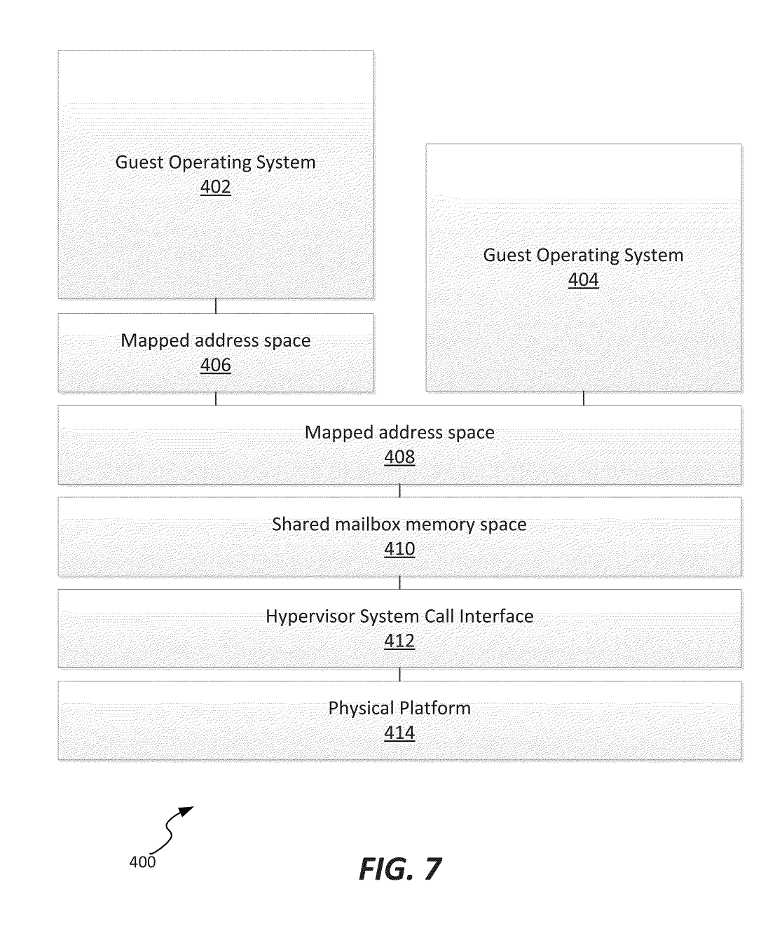

In FIG. 7, an exemplary embodiment of para-virtualization system 400 is shown, which allows multiple guest operating systems to run on the hypervisor system call interface 412, all within a single platform 414. For example, FIG. 7 illustrates two guest operating systems, Guest Operating System 402 and Guest Operating System 404. The guest partition for Guest Operating System 402 can see the full mapped address space 408 of Guest Operating System 404. Thus, Guest Operating System 404, as the first partition, is a server, while Guest Operating System 402, as the second partition, is a client. The hypervisor system call interface sees the mailbox space 410 as a fixed size. The size of the mailbox is modified in the XML structural file configuration during boot of the hypervisor system call interface. Thus, the mailbox is fixed for each boot of the hypervisor system call interface.

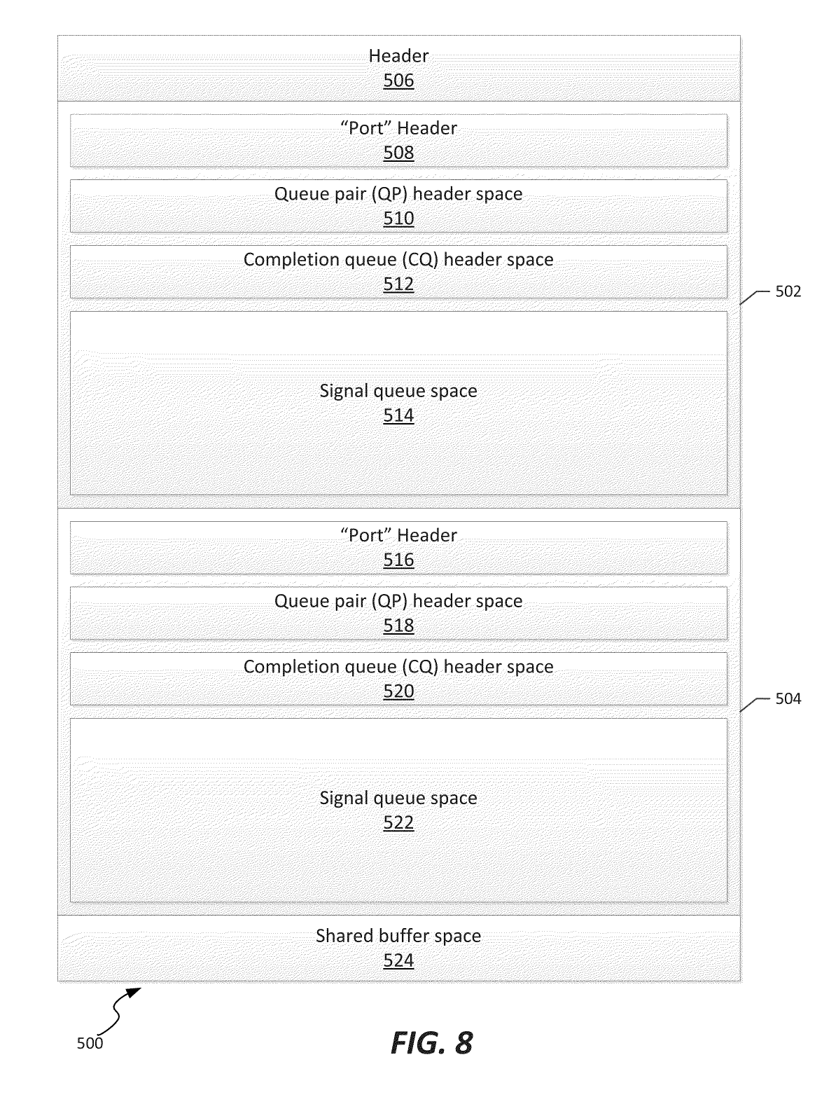

Referring to FIG. 7 and FIG. 8, when the shared memory driver loads 608 in the server guest 604, it collects the configuration information from the hypervisor system call interface 602. With this information, the shared memory driver 608 initializes the mailbox structure 500, as shown in FIG. 8. The header 506 is initialized with information about the size of the ports and the size of the shared buffer space 524. The mailbox size, less the header and shared buffer space, is divided into two equally sized ports, 502 and 504. Upon completion of initialization, the client shared memory driver is notified by a hypervisor system call interface internal messaging mechanism. Both shared memory drivers then use more configuration information to determine how much space to allocate to each type of structure. The QP space, 510 and 518, will contain a fixed number of structures based in part upon configuration provided in the parameter file. Each of these QPs will have, at a minimum, a send signal queue and a receive signal queue. However, each QP may also have a send and/or receive completion queue. Because the application decides how large the signal queues are and whether CQs are to be associated, signal queues are not allocated until the application requests them. CQs, 512 and 520, are also a fixed number based upon configuration. When an application requests a CQ, a related signal queue is also allocated. The signal queue space, 514 and 522, is split up as the application makes requests, providing space after the QPs and CQs are initialized by the driver. Shared buffer space 524 provides small memory transfers between guests.

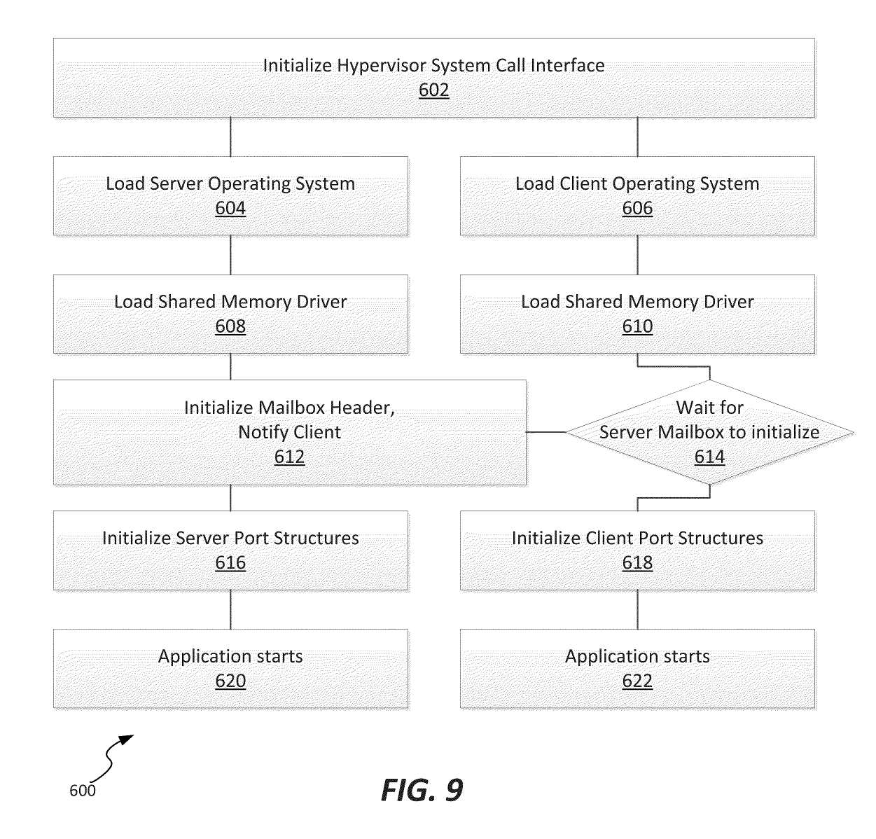

Referring to FIG. 9, the mailbox 612 may be initialized after the server shared memory driver 608 loads. Thus, the number of structures within the mailbox space can be modified by amending the XML structural file from the hypervisor system call interface 602 and resetting the server shared memory driver 608. For example, the below XML script shows an exemplary configuration file.

```
<inv:Port Index=“2” Type=“RDMA” Id=“C2E80172-CC61-11DD-
      B690-444553544200” Name=“vRDMA-9-0-2” MemKB=“4”>
<inv:Client PartitionId=“72120122-4AAB-11DC-8530-
      444553544200” PartitionName=“JProcessor-2” Id=“18a17879-
      3593-4048-adc7-10d39444c3b9” Create=“true”
      VectorCount=“0”>
<inv:Description>JProc 2 to JProc 1 - vRDMA</inv:Description>
<inv:Connection>visible:false</inv:Connection>
<inv:Target />
<inv:Initiator>PortIPAdrs:192.168.90.2</inv:Initiator>
<inv:Config>QP:2,MR:1,Reg:5000,SQDepth:128,RQDepth:128,SSge:16,
      RSge:16,TXLen:5000,CQDepth:256,PD:1,SBuf:9000<
      /inv:Config>
</inv:Client>
</inv:Port>
```

In this example, the inv:Config script line is set to a max send depth of 128 and a max receive depth of 128. When hypervisor system call interface boots, it will parse this XML script and store the information so that it is accessible by the shared memory driver. Previously, the mailbox contained a fixed number of QPs and CQs, each of which had a fixed size signal queue.

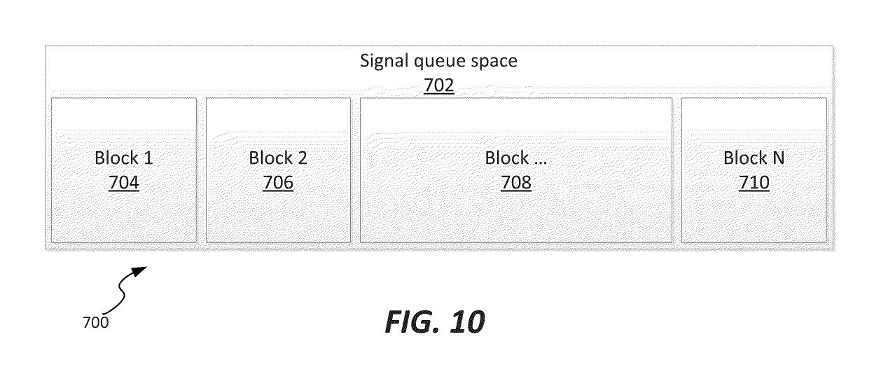

As shown in FIG. 10, a signal queue space 702 is split into blocks, which may be aligned on a 64 byte boundary. An arbitrary fixed depth of 16 may be used. As the application requests structures from the driver, these blocks are consumed. At the start of each block, there is information about that block. The information provides whether or not the block is allocated, and further, how many blocks are associated with that block. For example, if there are 100 blocks, none of which are allocated, then the information in the first block will say the block is not allocated and there are 100 blocks associated. If an application requests a QP with a send depth of 16 and a receive depth of 32, Block 1, 704, will be allocated to the send queue and show 1 block associated with it. Block 2, 706, and Block 3, first block of 708, will be allocated to the receive queue. Each block will show 2 blocks associated. Block 4, unused, will show 97 blocks associated, as Blocks 1-3 were consumed. If the receive queue is freed, the blocks will recombine and will again be available for allocation. Allocation occurs completely during runtime as message queues are submitted. For example, if an application requests a queue capable of holding 128 entries, a 128 entry queue is allocated (presuming it is available). If a message queue requests a 16 entry queue, a 16 entry queue is allocated. The mailbox channel is created as the shared memory driver initializes, while the queues are allocated from within the mailbox channel space. As queues are freed, they are recombined with any neighboring queues and placed back into the available pool.

II. Hardware Correspondence with Para-Virtualization Architecture

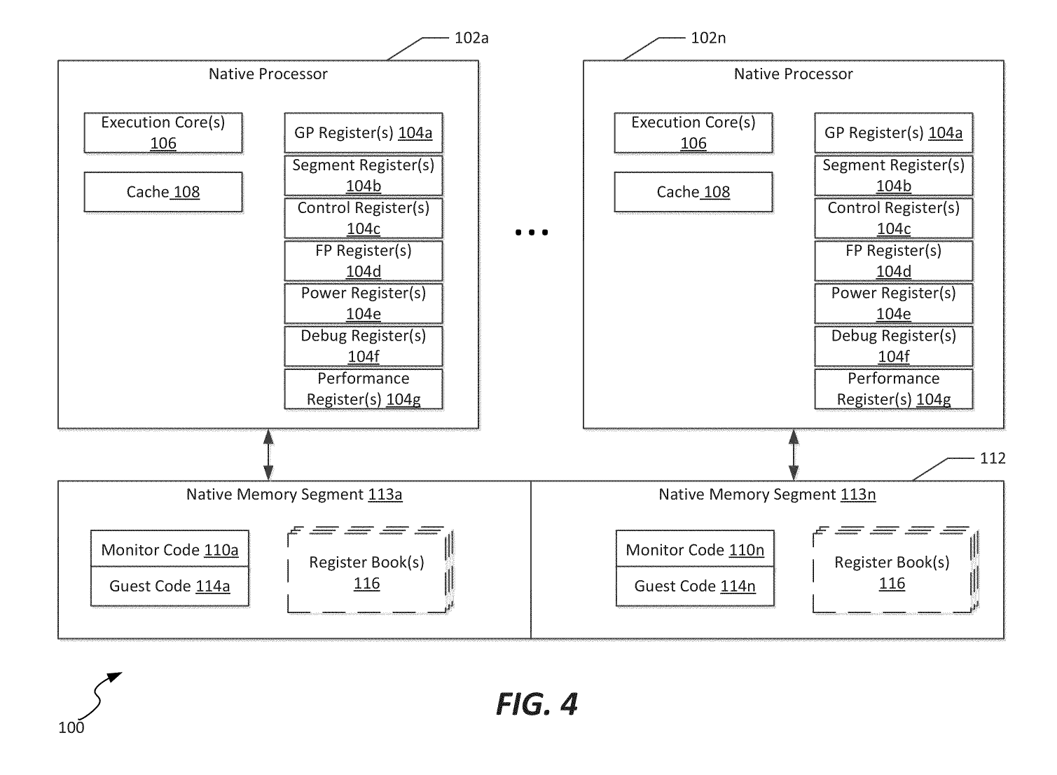

Referring now to FIG. 4, an example arrangement 100 showing correspondence between hardware, virtualized software, and virtualization systems are shown according to one example implementation of the systems discussed above. In connection with the present disclosure, and unlike traditional virtualization systems that share physical computing resources across multiple partitions to maximize utilization of processor cycles, the host system 10 generally includes a plurality of processors 102, or processing units, each of which is dedicated to a particular one of the partitions. Each of the processors 102 has a plurality of register sets. Each of the register sets corresponds to one or more registers representing a common set of registers, with each set representing a different type of register. Example types of registers, and register sets, include general purpose registers 104a, segment registers 104b, control registers 104c, floating point registers 104d, power registers 104e, debug registers 104f, performance counter registers 104g, and optionally other special-purpose registers (not shown) provided by a particular type of processor architecture (e.g., MMX, SSE, SSE2, et al.). In addition, each processor 102 typically includes one or more execution units 106, as well as cache memory 108 into which instructions and data can be stored.

In the particular embodiments of the present disclosure discussed herein, each of the partitions of a particular host system 10 is associated with a different monitor 110 and a different, mutually exclusive set of hardware resources, including processor 102 and associated register sets 104a-g. That is, although in some embodiments discussed in U.S. Pat. No. 7,984,104, a logical processor may be shared across multiple partitions, in embodiments discussed herein, logical processors are specifically dedicated to the partitions with which they are associated. In the embodiment shown, processors 102a, 102n are associated with corresponding monitors 110a-n, which are stored in memory 112 and execute natively on the processors and define the resources exposed to virtualized software. The monitors, referred to generally as monitors 110, can correspond to any of the monitors of FIGS. 1-3, such as monitors 36 or monitor 34 of the ultravisor partition 14. The virtualized software can be any of a variety of types of software, and in the example illustrated in FIG. 4 is shown as guest code 114a, 114n. This guest code, referred to herein generally as guest code 114, can be non-native code executed as hosted by a monitor 110 in a virtualized environment, or can be a special purpose code such as would be present in a boot partition 12, ultravisor partition 14, I/O partition 16, 18, command partition 20, or operations partition 22. In general, and as discussed above, the memory 112 includes one or more segments 113 (shown as segments 113a, 113n) of memory allocated to the specific partition associated with the processor 102.

The monitor 110 exposes the processor 102 to guest code 114. This exposed processor can be, for example, a virtual processor. A virtual processor definition may be completely virtual, or it may emulate an existing physical processor. Which one of these depends on whether Intel Vanderpool Technology (VT) is implemented. VT may allow virtual partition software to see the actual hardware processor type or may otherwise constrain the implementation choices. The present invention may be implemented with or without VT.

It is noted that, in the context of FIG. 4, other hardware resources could be allocated for use by a particular partition, beyond those shown. Typically, a partition will be allocated at least a dedicated processor, one or more pages of memory (e.g., a 1 GB page of memory per core, per partition), and PCI Express or other data interconnect functionality useable to intercommunicate with other cores, such as for I/O or other administrative or monitoring tasks.

As illustrated in the present application, due to the correspondence between monitors 38 and the processors 102, partitions are associated with logical processors on a one-to-one basis, rather than on a many-to-one basis as in conventional virtualization systems. When the monitor 110 exposes the processor 102 for use by guest code 112, the monitor 110 thereby exposes one or more registers or register sets 104 for use by the guest code. In example embodiments discussed herein, the monitor 110 is designed to use a small set of registers in the register set provided by the processor 102, and optionally does not expose those same registers for use by the guest code. As such, in these embodiments, there is no overlap in register usage between different guest code in different partitions, owing to the fact that each partition is associated with a different processor 102. There can also be no overlap, in the event of judicious design of the monitor 110, between registers used by the monitor 110 and the guest code 114.

In such arrangements, if a trap is detected by the monitor 110 (e.g., in the event of an interrupt or context switch), fewer than all of the registers used by the guest code need to be preserved in memory 112. In general, and as shown in FIG. 4, the memory 112 can include one or more sets of register books 116. Each of the register books 116 corresponds to a copy of the contents of one or more sets of registers used in a particular context (e.g., during execution of guest code 114), and can store register contents for at least those software threads that are not actively executing on the processor. For example, in the system as illustrated in FIG. 4, a first register book may be maintained to capture a state of registers during execution of the guest code 114, and a second register book may be maintained to capture a state of the same registers or register sets during execution of monitor code 110 (e.g., which may execute to handle trap instances or other exceptions occurring in the guest code. If other guest code were allowed to execute on the same processor 102, additional register books would be required.

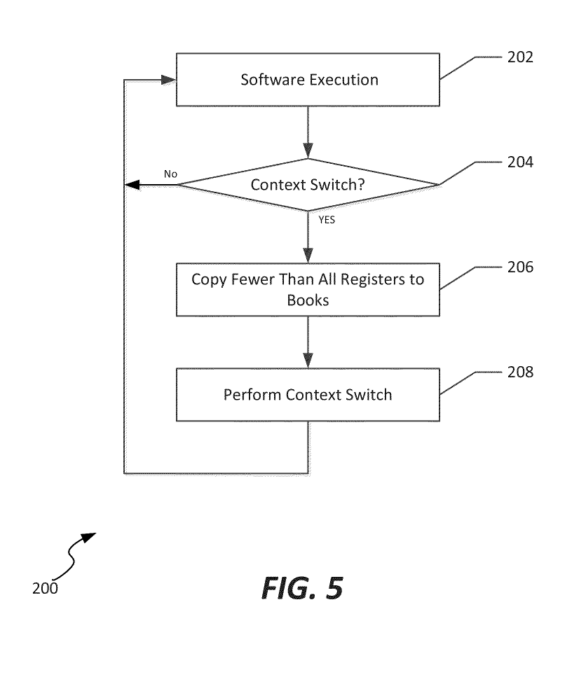

As further discussed below in connection with FIG. 5, in the context of the present disclosure, where registers are exposed via a monitor 110 to particular guest code 114 in the architecture discussed herein, at least some of the registers are not reused due to the fact of a dedicated processor to the partition, as well as non-overlapping usage of register sets by the monitor 110 and guest code 114. Therefore, the register books 116 associated with execution of that software on the processor 102 need only store less than the entire contents of the registers used by that software. Furthermore, in an arrangement in which there is no commonality of use of register sets between the monitor 110 and the guest code 114, register books 116 can be either avoided entirely in that arrangement, or at the very least need not be updated in the event of a context switch in the processor 102.

It is noted that, in some embodiments discussed herein, such as those where an IA32 instruction set is implemented, maintenance of specific register sets in the register books 116 associated with a particular processor 102 and software executing thereon can be avoided. Example specific register sets that can be removed from register books 116 associated with the monitor 110 and guest code 114 can include, for example, floating point registers 104d, power registers 104e, debug registers 104f, performance counter registers 104g.

In the case of floating point registers 104d, it is noted that the monitor 110 is generally not designed to perform floating point mathematical operations, and as such, would in no case overwrite contents of any of the floating point registers in the processor 102. Because of this, and because of the fact that the guest code 114 is the only other process executing on the processor 102, when context switching occurs between the guest software and the monitor 110, the floating point registers 104d can remain untouched in place in the processor 102, and need not be copied into the register books 116 associated with the guest code 114. As the monitor 110 executes on the processor 102, it would leave those registers untouched, such that when context switches back to the guest code 114, the contents of those registers remains unmodified.

In an analogous scenario, power registers 104e also do not need to be stored in register books 116 or otherwise maintained in shadow registers (in memory 112) when context switches occur between the monitor 110 and the guest code 114. In past versions of hypervisors in which processing resources are shared, power registers may not have been made available to the guest software, since the virtualized, guest software would have been restricted from controlling power/performance settings in a processor to prevent interference with other virtualized processes sharing that processor. By way of contrast, in the present arrangement, the guest code 114 is allowed to adjust a power consumption level, because the power registers are exposed to the guest code by the monitor 110; at the same time, the monitor 110 does not itself adjust the power registers. Again, because no other partition or other software executes on the processor 102, there is no requirement that backup copies of the power registers be maintained in register books 116.

In a still further scenario, debug registers 104f, performance counter registers 104g, or special purpose registers (e.g., MMX, SSE, SSE2, or other types of registers) can be dedicated to the guest code 114 (i.e., due to non-use of those registers by the monitor 110 and the fact that processor 102 is dedicated to the partition including the guest code 114), and therefore not included in a set of register books 116 as well.

It is noted that, in addition to not requiring use of additional memory resources by reducing possible duplicative use of registers between partitions, there is also additional efficiency gained, because during each context switch there is no need for delay while register contents are copied to those books. Since many context switches can occur in a very short amount of time, any increase in efficiency due to avoiding this task is multiplied, and results in higher-performing guest code 114.

Additionally, and beyond the memory resource usage savings and overhead reduction involved during a context switch, the separation of resources (e.g., register sets) between the monitor 110 and guest code 114 leads to simplification of the monitor is provided as well. For example, by using no floating point operations, the code base and execution time for the monitor 110 can be reduced.

It is noted that, in various embodiments, different levels of resource dedication to virtualized software can be provided. In some embodiments, the monitor 110 and the guest code 114 operate using mutually exclusive sets of registers, such that register books can be completely eliminated. In such embodiments, the monitor 110 may not even expose the guest code 114 to the registers dedicated for use by the monitor.

Referring to FIG. 5, an example flowchart is illustrated that outlines a method 200 for reducing overhead during a context switch, according to a possible embodiment of the present disclosure. The method 200 generally occurs during typical execution of hosted, virtualized software, such as the guest code 114 of FIG. 5, or code within the various guest or special-purpose partitions discussed above in connection with FIGS. 1-3.

In the embodiment shown, the method 200 generally includes operation of virtualized software (step 202), until a context switch is detected (step 204). This can occur in the instance of a variety of events, either within the hardware, or as triggered by execution of the software. For example, a context switch may occur in the event that an interrupt may need to be serviced, or in the event some monitor task is required to be performed, for example in the event of an I/O message to be transferred to an I/O partition. In still other examples, the ultravisor partition 14 may opt to schedule different activity, or reallocate computing resources among partitions, or perform various other scheduling operations, thereby triggering a context switch in a different partition. Still other possibilities may include a page fault or other circumstance.

When a need for a context switch is detected, the monitor may cause exit of the virtualization mode for the processor 102. For example, the processor may execute a VMEXIT instruction, causing exit of the virtualization mode, and transition to the virtual machine monitor, or monitor 110. The VMEXIT instruction can, in some embodiments, trigger a context switch as noted above.

Upon occurrence of the context switch, the processor 102 will be caused (by the monitor 110, after execution of the VMEXIT instruction) to service the one or more reasons for the VMEXIT. For example, an interrupt may be handled, such as might be caused by I/O, or a page fault, or system error. In particular, the monitor code 110 includes mappings to interrupt handling processes, as defined in the control service partition discussed above in connection with FIGS. 1-3 In embodiments in which no register overlap exists, this context switch can be performed directly, and no delay is required to store a state of register sets, such as floating point register sets, debug or power/performance register sets. Furthermore, because cores are assigned specifically to instances of a single guest partition (e.g., a single operating system), there is no ping-ponging between systems on a particular processor, which saves the processing resources and memory resources required for context switching.

In connection with FIG. 5, at least some of the register sets in a particular processor 102 are not stored in register books 116 in memory 112 (step 206). As noted above, in some embodiments, storing of register contents in register books can be entirely avoided. After the state of any remaining shared registers is captured following the VMEXIT, a context switch can occur (step 208). In general, this can include execution of the monitor code 110, to service the interrupt causing the VMEXIT (e.g., returning to step 202). Once that servicing by the monitor has completed, a subsequent context switch can be performed (e.g. via a VMRESUME instruction or analogous instruction), and any shared registers restored (step 206) prior to resuming operation of the guest code (step 208).

Referring to FIGS. 1-5, it is noted that in the general case, it is preferable to be executing the guest code 114 on the processor 102 as much as possible. However, in the case of a virtualized workload in a guest partition that invokes a large number of I/O operations, there will typically be a large number of VMX operations (VMEXIT, VMRESUME, etc.) occurring on that processor due to servicing requirements for those I/O operations. In those circumstances, performance savings based on avoidance of storage of register books and copying of register contents can be substantial, in particular due to the hundreds of registers often required to be copied in the event of a context switch.

Furthermore, it is noted that although some resources are not shared between guest software and the monitor, other resources may be shared across types of software (e.g., the monitor 110 and guest 114), or among guests in different partitions. For example, the boot partition may be shared by different guest partitions, to provide a virtual ROM with which partitions can be initialized. In such embodiments, the virtual ROM may be set as read-only by the guest partitions (e.g., partitions 24, 26, 28), and can therefore be reliably shared across partitions without worry of it being modified incorrectly by a particular partition.

Referring back to FIG. 4, it is noted that, in various embodiments, the dedication of processor resources to particular partitions has another effect, in that hardware failures occurring in a particular processor can be recovered from, even if such an error occurs in the event of a device failure, and even in the case where the event occurs in a partition other than a guest partition. In particular, consider the case where the various processors 102a-n execute concurrently, and execute software defining various partitions, including the ultravisor partition 14, I/O partition 16a-b, command partition 20, operations partition 22, or any of a variety of guest partitions 24, 26, 28 of FIGS. 1-3. In general, the partitions 14-22, also referred to herein as control partitions, provide monitoring and services to the guest partitions 24-28, such as boot, I/O, scheduling, and interrupt servicing for those guest partitions, thereby minimizing the required overhead of the monitors 36 associated with those partitions. In the context of the present disclosure, a processor 102 associated with each of these partitions may fail, for example due to a hardware failure either in the allocated processor or memory. In such cases, any of the partitions that use that hardware would fail. In connection with the present disclosure, enhanced recoverability of the para-virtualization systems discussed herein can be provided by separation and dedication of hardware resources in a way that allows for easier recoverability. While the arrangement discussed in connection with U.S. Pat. No. 7,984,108 discusses partition recovery generally, that arrangement does not account for the possibility of hardware failures, since multiple monitors executing on common hardware would all fail in the event of such a hardware failure.

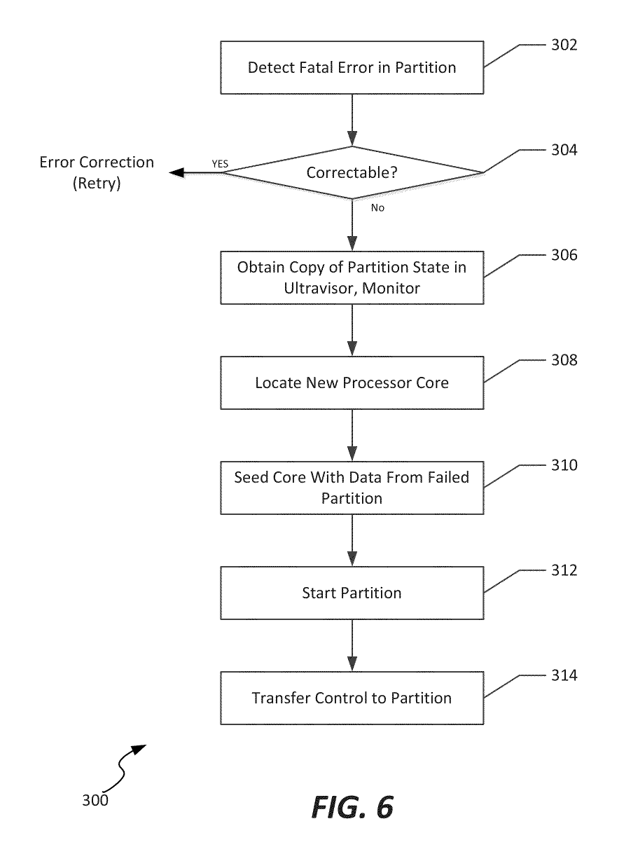

Referring now to FIGS. 4 and 6, an example method by which fatal errors can be managed by such a para-virtualization system is illustrated, and discussed in terms of the host system 10 of FIG. 4. In particular, a method 300 is shown that may be performed for any partition that experiences a fatal error that may be a hardware or software error, where non-stop operation of the para-virtualization system is desired and hardware resources are dedicated to specific partitions. In general, the para-virtualization system stores sufficient information about a state of the failed partition such that the partition can be restored on different hardware in the event of a hardware failure (e.g., in a processing core, memory, or a bus error).

In the embodiment shown, the method 200 occurs upon detection of a fatal error in a partition that forms a part of the overall arrangement 100 (step 302). Generally, this fatal error will occur in a partition, which could be any of the partitions discussed above in connection with FIGS. 1-3, but having a dedicated processor 102 and memory resources (e.g., memory segment 113), as illustrated in connection with FIG. 4. In the event of such a fatal error, which could occur either during execution of the hosted code (i.e., guest code 114 of FIG. 4) or the monitor code 110, will trigger an interrupt, or trap, to occur in the processor 102. The interrupt can be mapped, for example by a separate control partition, such as command partition 20, to an interrupt routine to be performed by the monitor of that partition and/or functions in the ultravisor partition 14. That interrupt processing routine can examine the type of error that has occurred (step 304). The error can be either a correctable error, in which case the partition can be corrected and can resume operation, or an uncorrectable error.

In the event an uncorrectable error occurs, the ultravisor partition 14, alongside the partition in which the error occurred, cooperate to capture a state of the partition experiencing the uncorrectable error (step 306). This can include, for example, triggering a function of the ultravisor partition 14 to copy at least some register contents from a register set 104 associated with the processor 102 of the failed partition. It can also include, in the event of a memory error, copying contents from a memory area 113, for transfer to a newly-allocated memory page. Discussed in the context of the arrangement 100 of FIG. 4, if the ultravisor is implemented in guest code 114a and a guest partition is implemented in guest code 114n, the processor 102n would trigger an interrupt based on a hardware error, such as in the execution unit 106 or cache 108 of processor 102n. This would trigger handling of an interrupt with monitor 110n (e.g., via a VMEXIT). The monitor 110n communicates with monitor 110a which in this scenario would correspond to monitor 34 of ultravisor partition 14 (and guest code 114n would correspond to the ultravisor partition itself). The ultravisor partition code 110a would coordinate with monitor code 110n to obtain a snapshot of memory segment 113n and the registers/cache from processor 102n.

Once the state of the failed partition is captured, the ultravisor partition code (in this case, code 110a) allocates a new processor from among a group of unallocated processors (e.g., processor 110m, not shown) (step 308). Unallocated processors can be collected, for example, in an idle partition 12 as illustrated in FIGS. 1-3. The ultravisor partition code can also allocate a new corresponding page in memory for the new processor, or can associate the existing memory page from the failed processor for use with the new processor (assuming the error experienced by the failed partition was unrelated to the memory page itself). This can be based, for example, on data tracked in a control service partition, such as ultravisor partition 14, command partition 20 or operations partition 22. The new processor core is then seeded, by the ultravisor partition, with captured state information, such as register/cache data (step 310), and that new partition would be started, for example by a control partition. Once seeded and functional, that new partition, using a new (and non-failed) processor, would be given control by the ultravisor partition (step 314).

In various embodiments discussed herein, different types of information can be saved about the state of the failed partition. Generally, sufficient information is saved such that, when the monitor or partition crashes, the partition can be restored to its state before the crash occurs. This typically will include at least some of the register or cache memory contents, as well as an instruction pointer.

It is noted that, in conjunction with the method of FIG. 6, it is possible to track resource assignments in memory and accurate/successful transactions, such that a fault in any given partition will not spoil the data stored in that partition, so that other partitions can intervene to obtain that state information and transition the partition to new hardware. To the extent transactions are not completed, some rollback or re-performance of those transactions may occur. For example, in the context of the method 200, and in general relating to the overall arrangement 100, the instruction pointer used in referring to a particular location in the virtualized software (i.e., the guest code 114 in a given partition) is generally not advanced until any interrupt condition is determined to be handled successfully (e.g., based on a successful VMEXIT and VMRESUME), the system state captured using method 200 is accurate as of the time immediately preceding the detected error. Furthermore, because the partitions are capable of independent execution, the failure of a particular monitor instance or partition instance will generally not affect other partitions or monitors, and will allow for straightforward re-integration of the partition (once new hardware is allocated) into the overall arrangement 100.

It is noted that in the arrangement disclosed herein, even when one physical core has an error occurring therein, the remaining cores, monitors, and partitions need not halt, because each monitor is effectively self-sufficient for some amount of time, and because each partition is capable of being restored. It is further recognized that the various services, since they are monitored by watchdog timers, can fail and be transferred to available service physical resources, as needed.

Referring now to FIGS. 1-11 overall, embodiments of the disclosure may be practiced in various types of electrical circuits comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, aspects of the methods described herein can be practiced within a general purpose computer or in any other circuits or systems.

Embodiments of the present disclosure can be implemented as a computer process (method), a computing system, or as an article of manufacture, such as a computer program product or computer readable media. The computer program product may be a computer storage media readable by a computer system and encoding a computer program of instructions for executing a computer process. Accordingly, embodiments of the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media. Further, the disclosed methods' stages may be modified in any manner, including by reordering stages and/or inserting or deleting stages, without departing from the overall concept of the present disclosure.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method, comprising:
reading at least one mailbox parameter in a parameter file;
initializing a shared mailbox memory space in a first guest partition, the shared mailbox memory space accessible by a second guest partition different from the first guest partition, wherein the shared mailbox memory space is configured based, at least in part, on the at least one mailbox parameter; and
notifying the second guest partition after the shared mailbox memory space is initialized.

2. The method of claim 1, wherein said method executes non-native software on a computing system having a plurality of processing units, each processing unit configured to execute native instructions on separate guest partitions, each guest partition sharing a shared mailbox memory space with another guest partition.

3. The method of claim 1, wherein said parameter file is a XML file.

4. The method of claim 1, wherein:
said first guest partition includes a server operating system; and
said second guest partition includes a client operating system.

5. The method of claim 1, wherein the step of initializing is performed by a shared memory driver.

6. The method of claim 1, wherein said shared mailbox memory space created by said shared memory driver further comprises at least two ports.

7. The method of claim 5, wherein said at least two ports each further comprises:
at least one port header;
at least one queue pair header space;
at least one completion queue header space; and
at least one signal queue space.

8. The method of claim 3, wherein the computing system is incapable of native execution of the non-native software.

9. A computer program product comprising:
a non-transitory computer readable medium comprising:
code to read at least one mailbox parameter in a parameter file; and
code to initialize a shared mailbox memory space in a first guest partition, the shared mailbox memory space accessible by a second guest partition different from the first guest partition, wherein the shared mailbox memory space is configured based, at least in part, on the at least one mailbox parameter; and
code to notify the second guest partition after the shared mailbox memory space is initialized.

10. The computer program product of claim 9, wherein said method executes non-native software on a computing system having a plurality of processing units, each processing unit configured to execute native instructions on separate guest partitions, each guest partition sharing a shared mailbox memory space with another guest partition.

11. The computer program product of claim 9, wherein said parameter file is a XML file.

12. The computer program product of claim 9, wherein:
said first guest partition includes a server operating system; and
said second guest partition includes a client operating system.

13. The computer program product of claim 9, wherein the step of initializing is performed by a shared memory driver.

14. The computer program product of claim 9, wherein said shared mailbox memory space created by said shared memory driver further comprises at least two ports.

15. The computer program product of claim 9, wherein said at least two ports each further comprises:
at least one port header;
at least one queue pair header space;
at least one completion queue header space; and
at least one signal queue space.

16. A computing system for executing non-native software having a plurality of processing units, each processing unit configured to execute native instructions on separate guest partitions, each guest partition sharing a shared mailbox memory space with another guest partition, the computing system comprising:
at least one processor coupled to a memory, in which the at least one processor is configured to:
read at least one mailbox parameter in a parameter file; and
initialize a shared mailbox memory space in a first guest partition, the shared mailbox memory space accessible by a second guest partition different from the first guest partition, wherein the shared mailbox memory space is configured based, at least in part, on the at least one mailbox parameter; and
notify the second guest partition after the shared mailbox memory space is initialized.

17. The computing system of claim 16, wherein said parameter file is a XML file.

15. The computing system of claim 14, wherein the client operating system uses the mailbox created by the server shared memory driver.

18. The computing system of claim 15, wherein the mailbox created by the server shared memory driver further comprises two equally-sized ports.

19. The computing system of claim 16, wherein each said equally-sized port further comprises:
at least one port header;
at least one queue pair header space;
at least one completion queue header space; and
at least one signal queue space.

20. The computing system of claim 17, wherein the computing system is incapable of native execution of the non-native software.
